(19) United States
(12) Patent Application Publication
(10) Pub. No.: US 2017/0218768 A1
(43) Pub. Date: Aug. 3, 2017

(54) BLADE OF A TURBOMACHINE HAVING BLADE ROOT THERMAL INSULATION

(71) Applicant: MTU Aero Engines AG, Munich (DE)

(72) Inventor: Alexander BOECK, Kottgeisering (DE)

(21) Appl. No.: 15/420,197

(22) Filed: Jan. 31, 2017

(30) Foreign Application Priority Data
Feb. 2, 2016 (DE) 102016201523.0

(51) Int. Cl. F01D 5/08; F01D 5/30

(52) U.S. Cl. CPC F01D 5/08; F01D 5/3007; F01D 5/3092; F05D 2220/32; F05D 2260/231

(57) ABSTRACT

Disclosed is an arrangement for fastening a blade root of a blade of a turbomachine in a blade root receptacle, with a blade having a blade root of a first material and with a blade root receptacle of a second material, wherein a thermal barrier layer is arranged between the blade root and the blade root receptacle. Further disclosed is a blade having a blade root with a thermal barrier layer and also a method for operating a turbomachine, in which a blade having a blade root is received in a blade root receptacle and a blade root temperature which is above the blade root receptacle temperature is set.

### CROSS-REFERENCE TO RELATED APPLICATIONS

The present application claims priority under 35 U.S.C. §119 of German Patent Application No. 102016201523.0, filed Feb. 2, 2016, the entire disclosure of which is expressly incorporated by reference herein.

### BACKGROUND OF THE INVENTION

1. Field of the Invention

The present invention relates to an arrangement for fastening a blade root of a blade of a turbomachine in a blade root receptacle and also to a blade for a turbomachine and to a method for operating a turbomachine.

2. Discussion of Background Information

Turbomachines, such as stationary gas turbines or aero engines, are provided with a multiplicity of blades, which are fastened as rotor blades on a rotating rotor or are arranged as guide blades (also referred to as guide vanes) in a stationary manner in the turbomachine. In the region of the airfoils of the guide blades and of the rotor blades, the fluid of the turbomachine, such as for example air, is conducted through the turbomachine, such that, after compression of the fluid in the compressor and ignition of a suitable fuel-fluid mixture in the combustion chamber, the outflowing combustion gas can drive a rotor, which in turn can drive the compressor. Accordingly, both rotor blades and guide blades in the flow duct of the turbomachine have to satisfy high demands, since they can be exposed to high temperatures, high levels of mechanical loading and also aggressive media. Consequently, it is often advantageous and/or necessary to manufacture the blades from a specific material which satisfies the specific demands In particular, the material of the blades may differ from the material of the components of the flow system which are adjacent to the blades, such as for example the material of the disks of a rotor or other blade receptacles in which the blades are received. The use of different materials for the blades and adjacent components, such as rotor disks, casing, etc., arises on account of the specific and complex demands for the blades and the associated high costs for the corresponding material for the blades and/or on account of a different demand profile of the components of the turbomachine which are adjacent to the blades, such that the same material as for the blades cannot or should not be used for such components.

Connections between the blade and adjacent components which are made of different materials are therefore necessary, however, and these can entail corresponding problems.

By way of example, wear can occur as a result of a relative movement at the connection points between the individual components, such as the blades and in particular the rotor blades, on the one hand, and the rotor disks, in which they are received, on the other hand, but it is also possible for other problems to arise as a result of corrosion, in particular fretting, or as a result of mechanical loading by stress peaks on account of linear or point contacts between the blade and the disk.

In order to solve these problems, EP 2 719 865 A1, the entire disclosure of which is incorporated by reference herein, for example, describes an inlay for a blade-disk connection of a turbomachine, wherein the inlay is formed from a fiber material and/or foam material in which a lubricant can be incorporated in order to reduce the wear during a relative movement between the blade and the blade receptacle. WO 96/41068 A1, the entire disclosure of which is incorporated by reference herein, likewise proposes an inlay between a blade and a blade receptacle which is arranged on one of the contact surfaces by the use of adhesive.

U.S. Pat. No. 8,545,183, the entire disclosure of which is incorporated by reference herein, proposes sealing a gap between a blade root and a blade root receptacle by an appropriate coating. US 2007/0048142 A1, the entire disclosure of which is incorporated by reference herein, in turn discloses, for improving the resistance to contact pressures in a blade-disk connection, the provision of a non-metallic layer comprising polyamide, while EP 2 423 442 A2, the entire disclosure of which is incorporated by reference herein, proposes a rub strip, wherein provision is additionally made of an electrically insulating material in order to avoid damage on account of electromotive forces. WO 2013/169271 A1, the entire disclosure of which is incorporated by reference herein, proposes the provision of a woven plastics material for the blade root of a blade of a fan, in order to avoid wear to the blade root in a blade root receptacle.

Even though the various known blade root-blade root receptacle connections have already made it possible to use different materials for the blade and the blade root receptacle and to effectively connect these components, there continues to be a need to use specially adapted materials for the various components of blade and blade receptacle, where, however, the connecting region of the components is to be configured in such a way that, given maximum exploitation of the potential of the materials, a high service life of the connection of the components and an optimum use of the individual components are achieved. At the same time, it should be possible to establish and use a corresponding solution in a simple and reliable manner.

### SUMMARY OF THE INVENTION

The present invention provides an arrangement for fastening a blade root of a blade of a turbomachine in a blade root receptacle. The blade comprises a blade root of a first material and the blade root receptacle is formed of a second material, and a thermal barrier layer is arranged between the blade root and the blade root receptacle.

In one aspect of the method, the thermal barrier layer may have a lower thermal conductivity than that of the first material of the blade root and the second material of the blade root receptacle.

In another aspect, the thermal barrier layer may be formed from ceramic material or comprise ceramic material.

In yet another aspect, the thermal conductivity of the thermal barrier layer may be not higher than about 50 W/mK, e.g., not higher than about 25 W/mK, or not higher than about 1 W/mK.

In a still further aspect, the thermal barrier layer may be coated onto the blade root and/or the boundary wall of the blade root receptacle. Further, a ductile layer may be deposited on the thermal barrier layer, the ductility of said ductile layer being greater than the ductility of the thermal barrier layer. By way of example, the ductile layer may be formed from a metallic material and/or the material of the ductile layer may have an elongation at break of more than about 5%, e.g., more than about 10%.

The present invention also provides a blade for a turbomachine having a blade root to be received in a blade root receptacle. The blade root comprises a thermal barrier layer.

In one aspect of the blade, the thermal barrier layer may have a lower thermal conductivity than that of the material of the blade root.

In another aspect, the thermal barrier layer may be formed from ceramic material or may comprise ceramic material.

In yet another aspect, the thermal conductivity of the thermal barrier layer may be not higher than about 50 W/mK, e.g., not higher than about 25 W/mK, or not higher than about 1 W/mK.

In a still further aspect of the blade, a ductile layer may be present on the thermal barrier layer, the ductility of the ductile layer being greater than the ductility of the thermal barrier layer. For example, the ductile layer may be formed from metallic material and/or the material of the ductile layer may have an elongation at break of more than 5%, e.g., more than 10%.

The present invention also provides a method for operating a turbomachine. The method comprises using a blade having a blade root received in a blade root receptacle (for example, the blade set forth above and/or the blade made according to the method set forth above) and setting a blade root temperature which is above the blade root receptacle temperature.

In one aspect of the method, a thermal barrier layer may be arranged between the blade root and the blade root receptacle, and a temperature difference during the operation of the turbomachine between the side of the thermal barrier layer on the blade root and the side of the thermal barrier layer on the blade root receptacle may be at least about 25° C., e.g., at least about 50° C., or at least about 100° C.

In another aspect, the blade root temperature during the operation of the turbomachine may be selected in such a way that a limit value of the ductility of the material from which the blade root is formed is exceeded and/or the blade root receptacle temperature may be selected in such a way that a limit value of the strength of the material of the blade root receptacle is exceeded and/or a limit value of the creep rate and/or of the oxidation or corrosion rate of a material of the blade root receptacle is undershot.

The present invention takes into account the fact that blades and blade receptacles in a turbomachine preferably are to be operated at different operating temperatures, in order to be able to use optimized materials in a correspondingly targeted manner for the different desired operating temperatures. Accordingly, it is proposed to set a temperature gradient in the region of the blade-blade receptacle connection, for example between a blade root of a rotor blade and a blade root receptacle in a rotor disk, such that the blade root can be operated at a higher operating temperature than the material which forms the blade root receptacle. As a result, cooling of the blade root region can be dispensed with or this can at least be reduced, and the blade root can be manufactured from a material which is optimized for higher use temperatures. This also no longer gives rise to the problem that, at the connection point between the blade and the blade receptacle, the blade root actually has to be operated at excessively low temperatures on account of the temperature which has been adapted to the blade root receptacle, since the material of the blade is geared toward higher temperatures in the flow duct, such that the material in the temperature range at the blade root receptacle already exhibits brittle properties, whereas the temperature is actually too high for the material of the blade receptacle and said material can be damaged by overheating if the temperature in the region of the blade-blade receptacle connection is increased on account of the high blade temperatures in the blade root receptacle.

Accordingly, in accordance with the invention, the blade root temperature during the operation of the turbomachine can be set in such a way that a limit value of the ductility of the material from which the blade root is formed is exceeded, i.e. the blade root has a minimum ductility, such that no brittle material behavior of the material of the blade root occurs during operation of the turbomachine. At the same time or as an alternative, the blade root receptacle temperature, i.e. the temperature which the material of the blade root receptacle experiences during operation of the turbomachine, can be selected in such a way that a limit value of the strength of the material is exceeded, that is to say that a sufficient strength is retained even at the operating temperature of the turbomachine, and/or that a limit value of the creep rate and/or of the oxidation or corrosion rate of the material is undershot, that is to say that the oxidation or corrosion or the creep can be maintained below critical values. The operating temperature of the turbomachine is understood to mean the temperature of the corresponding structural parts or components which is reached as a maximum during normal continuous operation or with a maximum power of the turbomachine.

In order to make such an operation of a turbomachine possible, it is proposed that a thermal barrier layer is provided between the blade root and the blade root receptacle when a blade is arranged in a blade root receptacle, said thermal barrier layer making it possible to set a corresponding temperature gradient between the blade root and the blade root receptacle. The thermal barrier layer can accordingly be formed from a material which has a low thermal conductivity and in particular has a lower thermal conductivity than the material of the blade root and the material of the blade root receptacle.

The thermal barrier layer can preferably be formed from a ceramic material, such as aluminum oxide and/or zirconium oxide, or can comprise such a ceramic material.

The thermal barrier layer can preferably be selected in such a way that the thermal conductivity of the thermal barrier layer is lower than or equal to 50 W/mK and in particular lower than or equal to 25 W/mK, preferably lower than or equal to 1 W/mK.

When a blade root of a blade is arranged in a blade root receptacle of the turbomachine, the thermal barrier layer can be applied as a coating either to the blade root or on the boundary wall of the blade root receptacle, or can he arranged as a separate inlay between the corresponding structural parts. The thermal barrier layer can be provided in this respect at least in the region of a high level of heat transfer between the blade root and the blade root receptacle, preferably in the entire contact region between the blade root and the blade root receptacle. The blade and the blade root receptacle may be any desired suitable components of a turbomachine, in particular rotor blades which are arranged in a rotor, in particular a rotor disk.

In order to keep the level of mechanical loading of the thermal barrier layer low, a ductile layer can be deposited on the thermal barrier layer, the ductility of said ductile layer being greater in particular than the ductility of the thermal barrier layer. By virtue of such a ductile layer, it is possible for mechanical stress peaks to be avoided or reduced through corresponding deformation of the ductile layer.

The ductile layer can accordingly be formed from a metallic material. The ductile layer can have in particular an elongation at break of more than 5%, preferably more than 10%.

Accordingly, a further aspect of the present invention, autonomously and independently of other aspects of the present invention, claims a blade for a turbomachine, in which the blade root has a corresponding thermal barrier layer as has already been described above in relation to the arrangement of a blade in a blade receptacle.

Accordingly, it is possible to operate the blade root of a rotor blade and a blade root receptacle in a rotor disk at different temperatures, such as to also facilitate the use of different materials for blades or blade root regions and structural parts containing the blade receptacle, such as rotor disks. This is advantageous particularly in the case of the new generations of turbomachines or aero engines equipped with a geared turbofan. The demands made in particular on rotor blades in such turbomachines are particularly high, since, to increase the efficiency, for example, the low-pressure turbine is operated at higher rotation speeds and with higher gas inlet temperatures than in the case of aero engines of earlier generations.

The present invention makes it possible, for example, to use blades or blade root regions made of TiAl alloys or molybdenum base alloys, while the associated rotor disk can be formed from an Ni base alloy, in particular a nickel base superalloy, such as e.g. INCONEL alloy 718 (trade name of Special Metals Corp.).

Base alloys or alloy designations with alloying details naming chemical elements at the first positions refer to alloys which have the chemical elements mentioned as components with the greatest proportion. Superalloys refer to alloys which still have sufficient structural strengths at high temperatures of above half the melting temperature.

### BRIEF DESCRIPTION OF THE DRAWINGS

The accompanying drawings show, purely schematically, in

FIG. 1 a perspective illustration of a blade of a turbomachine, and in

FIG. 2 a sectional view through a root region of a further blade of a turbomachine.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

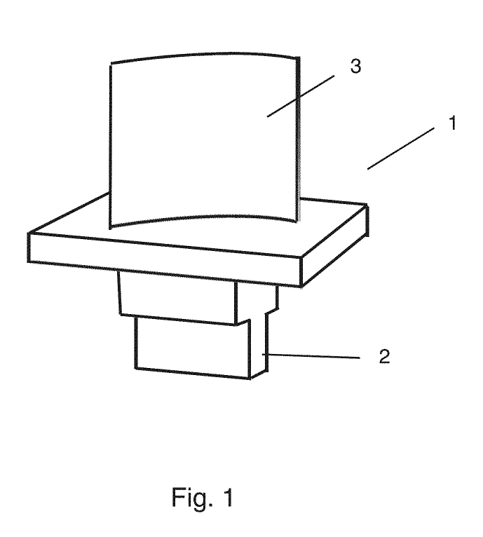

FIG. 1 shows a schematic example of a blade 1 of a turbomachine, such as for example a gas turbine or an aero engine. The blade 1 shown in FIG. 1 can be arranged, for example, as a rotor blade on a rotor of a turbomachine, wherein the root 2 of the blade 1 is received in a corresponding blade root receptacle (not shown) of a rotor disk or the like. In the case of the blade 1 shown in FIG. 1, the region of the blade root 2 which is received in a blade root receptacle is separated from the airfoil 3 by an inner shroud. However, the invention can also be used for other types of blades with different blade shapes, with or without inner and outer shrouds, and also different blade root shapes.

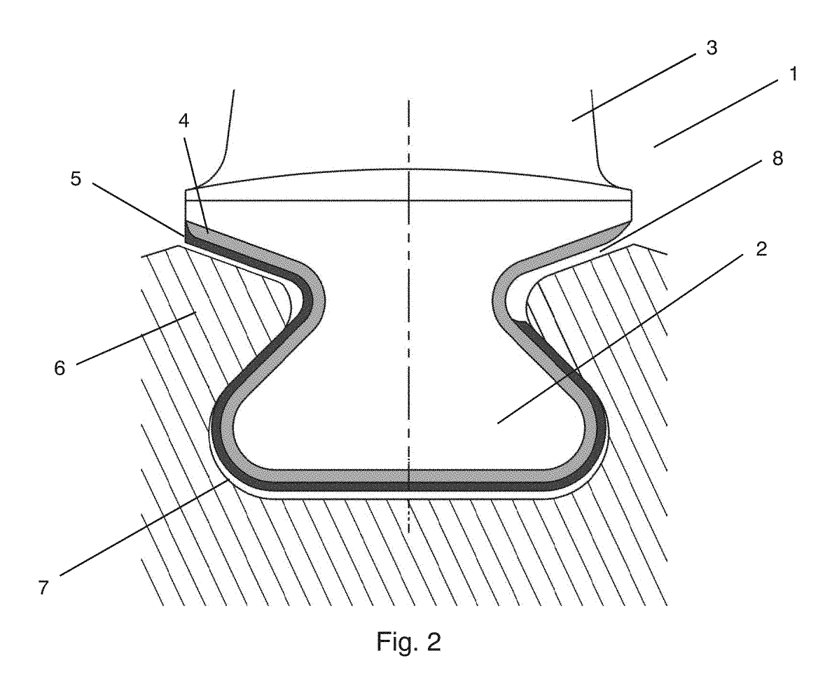

FIG. 2 shows a section through a comparable blade having a differently shaped blade root 2, with the blade root receptacle 7 of a rotor disk 6 additionally being shown in the sectional view.

The sectional illustration in FIG. 2 shows the structure according to the invention of the blade root having a thermal barrier layer 4, which is provided at least over the entire surface region of the blade root 2 which can come into contact with the inner wall region of the blade root receptacle 7.

In addition to the thermal barrier layer 4, a ductile layer 5 is applied to the thermal barrier layer 4 in the exemplary embodiment of FIG. 2. As is shown in the right-hand part of the blade root 2 of FIG. 2, the ductile layer 5 can be applied merely over partial regions of the thermal barrier layer 4, such that, in the remaining regions, in which no ductile layer 5 is provided, a gap 8 can be formed between the boundary wall of the blade root receptacle 7 and the thermal barrier layer 4 of the blade root 2. As an alternative, as is shown in the left-hand part of the blade root 2 of FIG. 2, however, the ductile layer 5 can also be applied substantially over the entire region of the thermal barrier layer 4. The left-hand part and the right-hand part of FIG. 2 therefore show two different embodiments with respect to the ductile layer 5.

According to the invention, the thermal harrier layer 4, which is arranged on the blade root 2 in the exemplary embodiment shown, but, in other exemplary embodiments, could also be arranged on the boundary wall of the blade root receptacle 7, is used to set a temperature gradient from the blade root 2 to the boundary wall of the blade root receptacle 7 or the disk or rotor material in which the blade root receptacle 7 is formed. The thermal barrier layer 4 makes it possible to set a higher temperature in the blade root 2, during operation of the turbomachine, than in the rotor disk 6 or the rotor. It is thereby possible to provide a material optimized for higher operating temperatures for the blade root 2, while a material optimized for a lower operating temperature can be used for the rotor disk 6. Correspondingly, the cooling of the blade root can also be reduced without having to fear that the material of the rotor disk 6 will be overheated.

By way of example, the rotor disk 6 could be formed from a nickel base material, while the blade or the blade root 2 could be formed from a nickel base superalloy having a higher use temperature or from another material having a higher use temperature, such that a temperature difference between the operating temperature of the blade root 2 and the operating temperature of the rotor disk 6 in the order of magnitude of 50° C. to 100° C. or higher can be set via the thermal barrier layer 4, in order to be able to correspondingly utilize the potential of the different materials of rotor disk 6 and blade 1.

Corresponding materials having a low thermal conductivity are suitable as the thermal barrier layer, such as for example ceramic thermal barrier layers or thermal barrier layers containing ceramic proportions. By way of example, materials consisting of or comprising aluminum oxide and/or zirconium oxide could be used.

The ductile layer 5, which can be formed from a suitable ductile material, such as for example a metallic material having a sufficiently high elongation at break, serves substantially for protecting the thermal barrier layer by the avoidance of stress peaks, which might arise in particular in the event of point or linear contact between the blade root 2 or the thermal barrier layer 4 arranged thereon and the blade root receptacle 7. By virtue of a ductile layer 5, possible manufacturing inaccuracies which could lead to such stress peaks can be compensated for in a simple manner, and the thermal harrier layer can he protected from instances of mechanical overloading. In addition, the ductile layer 5 can furthermore perform additional functions, such as for example with respect to the avoidance of frictional wear or the like.

Although the present invention has been described in detail on the basis of the exemplary embodiments, it is obvious to a person skilled in the art that the invention is not limited to these exemplary embodiments, but rather that modifications are possible in such a way that individual features can be omitted or different combinations of features can be implemented, without departing from the scope of protection of the accompanying claims. The disclosure of the present invention additionally includes all combinations of the individual features presented.

### LIST OF REFERENCE NUMERALS

1 Blade
2 Blade root
3 Airfoil
4 Thermal barrier layer
5 Ductile layer
6 Rotor disk
7 Blade root receptacle
8 Gap

What is claimed is:

1. An arrangement for fastening a blade root of a blade of a turbomachine in a blade root receptacle, wherein the blade comprises a blade root of a first material and the blade root receptacle is formed of a second material, and a thermal barrier layer is arranged between the blade root and the blade root receptacle.

2. The arrangement of claim 1, wherein the thermal barrier layer has a lower thermal conductivity than that of the first material of the blade root and the second material of the blade root receptacle.

3. The arrangement of claim 1, wherein the thermal barrier layer is formed from a ceramic material or comprises ceramic material.

4. The arrangement of claim 1, wherein the thermal conductivity of the thermal barrier layer is not higher than 50 W/mK.

5. The arrangement of claim 1, wherein the thermal conductivity of the thermal barrier layer is not higher than 25 W/mK.

6. The arrangement of claim 1, wherein the thermal conductivity of the thermal barrier layer is not higher than 1 W/mK.

7. The arrangement of claim 1, wherein the thermal barrier layer is coated onto the blade root and/or a boundary wall of the blade root receptacle.

8. The arrangement as claimed in claim 7, wherein a ductile layer is deposited on the thermal barrier layer, a ductility of the ductile layer being greater than a ductility of the thermal barrier layer.

9. The arrangement as claimed in claim 8, wherein the ductile layer is formed from metallic material and/or a material of the ductile layer has an elongation at break of more than 5%.

10. The arrangement as claimed in claim 9, wherein the material of the ductile layer has an elongation at break of more than 10%.

11. A blade for a turbomachine having a blade root to be received in a blade root receptacle, wherein the blade root comprises a thermal barrier layer.

12. The blade of claim 11, wherein the thermal barrier layer has a lower thermal conductivity than that of a material of the blade root.

13. The blade of claim 11, wherein the thermal barrier layer is formed from ceramic material or comprises ceramic material.

14. The blade of claim 11, wherein a thermal conductivity of the thermal barrier layer is not higher than 50 W/mK.

15. The blade of claim 11, wherein a thermal conductivity of the thermal barrier layer is not higher than 25 W/mK.

16. The blade of claim 11, wherein a ductile layer is present on the thermal barrier layer, a ductility of the ductile layer being greater than a ductility of the thermal barrier layer.

17. The blade as claimed in claim 16, wherein the ductile layer is formed from a metallic material and/or the material of the ductile layer has an elongation at break of more than 5%.

18. A method for operating a turbomachine, wherein the method comprises using a blade having a blade root received in a blade root receptacle and setting a blade root temperature which is above a blade root receptacle temperature.

19. The method of claim 18, wherein a thermal barrier layer is arranged between the blade root and the blade root receptacle, and a temperature difference during operation of the turbomachine between a side of the thermal barrier layer on the blade root and a side of the thermal barrier layer on the blade root receptacle is at least 25° C.

20. The method of claim 18, wherein the blade root temperature during operation of the turbomachine is selected in such a way that a limit value of a ductility of a material from which the blade root is formed is exceeded and/or wherein the blade root receptacle temperature is selected in such a way that a limit value of a strength of a material of the blade root receptacle is exceeded and/or a limit value of a creep rate and/or of an oxidation or corrosion rate of a material of the blade root receptacle is undershot.
